(19) United States
(12) Patent Application Publication
(10) Pub. No.: US 2018/0357661 A1
(43) Pub. Date: Dec. 13, 2018

(54) GENERATING ANALYTICS FOR A CONTENT ITEM PRESENTED TO INDIVIDUALS BY ONE OR MORE CONTENT PUBLISHERS BASED ON ATTRIBUTES EXTRAPOLATED FROM ONLINE SYSTEM USERS

(71) Applicant: Facebook, Inc., Menlo Park, CA (US)

(72) Inventors: Aleksey Sergeyevich Fadeev, Seattle, WA (US); Mehmet Gokhan Samur, Bellevue, WA (US)

(21) Appl. No.: 15/621,953

(22) Filed: Jun. 13, 2017

(51) Int. Cl. G06Q 30/02

(52) U.S. Cl. CPC G06Q 30/0242; G06Q 30/0251; G06Q 30/0277

(57) ABSTRACT

An online system provides content items to content publishers, which present them to individuals who may be online system users. The online system tracks the presentation of each content item and/or actions performed in association with the presentation of each content item using a tracking mechanism and identifies online system users from the individuals based on user-identifying information collected using the tracking mechanism and on information maintained in the online system. The online system determines a number of the online system users having various attributes and extrapolates a set of the individuals associated with each attribute (e.g., based on a sampling method that may de-bias the online system users). The online system generates analytics for the content items and communicates them to online system users associated with the content items, allowing the content items to be tailored to individuals to whom they may be presented by the content publishers.

### BACKGROUND

This disclosure relates generally to online systems, and more specifically to generating analytics for a content item presented to individuals by one or more content publishers based on attributes extrapolated from online system users.

An online system allows its users to connect and communicate with other online system users. Users create profiles in the online system that are tied to their identities and include information about the users, such as interests and demographic information. The users may be individuals or entities such as corporations or charities. Because of the popularity of online systems and the significant amount of user-specific information maintained in online systems, an online system provides an ideal forum for allowing users to share content by creating content items for presentation to additional online system users. For example, users may share photos or videos they have uploaded by creating content items that include the photos or videos that are presented to additional users to whom they are connected in the online system. An online system also provides advertisers with abundant opportunities to increase awareness about their products or services by presenting advertisements to online system users. For example, advertisements presented to users allow an advertiser to gain public attention for products or services and to persuade online system users to take an action regarding the advertiser's products, services, opinions, or causes.

To encourage online system users (e.g., advertisers) to provide content items (e.g., advertisements) for presentation to other online system users, online systems often offer such content-providing users with tools that track various events associated with content items and generate analytics based on the tracked events. For example, a tool provided by an online system may track presentations of a content item to online system users and purchases made by the users at a website to which the content item is linked. In this example, the tool also may generate analytics for the content item, which may describe a number of the online system users who were presented with the content item during a specific time period and a percentage of those users who made a purchase at the website to which the content item is linked.

Due to the significant amount of user-specific information maintained in online systems, an online system may incorporate user-specific information into analytics that are generated based on events associated with content items that are tracked by the online system. In the above example, the number of users who were presented with the content item and the percentage of the users who made a purchase at the website may be broken down by age group, gender, and income level. By leveraging the user-specific information maintained in online systems, online systems may provide new insights associated with content items (e.g., interests and demographic information associated with online system users who are likely to find the content items relevant), allowing content-providing users to tailor their content items to a target audience of the online system.

To further encourage content-providing users to provide content items for presentation to other online system users, online systems may offer to provide the content items to content publishers. For example, an online system may offer to provide a content item received from a content-providing user to multiple content publishers that each may present the content item to various individuals. By offering this service, online systems may attract advertisers and other users who have an interest in having content items presented by multiple content publishers, but who may find it complicated and time-consuming to provide the content items to each content publisher.

However, it may be difficult or impossible for online systems to incorporate user-specific information into analytics associated with content items presented by content publishers. For example, if a content item is presented by multiple content publishers, each content publisher may track various events associated with the content item and communicate analytics generated from the events to the online system so that they may be compiled. However, since each content publisher may not maintain the same amount of user-specific information as the online system, user-specific information cannot be incorporated into the compiled analytics. Thus, content-providing users of the online system may find analytics describing the performance of content items presented by content publishers to be limited in their ability to convey information that would allow the content-providing users to better tailor their content items to target audiences of different content publishers.

### SUMMARY

An online system (e.g., an online advertising system) receives content items (e.g., advertisements) from content-providing users of the online system and provides the content items to various content publishers, which present the content items to individuals who may be users of the online system. For example, if an advertiser provides an advertisement to the online system, the online system may provide the advertisement to multiple content publishers. In this example, each content publisher may then present the advertisement to individuals, some of whom may be online system users.

In some embodiments, the online system may store a content item in conjunction with various types of information upon receiving the content item from a content-providing user of the online system. For example, the online system may store a content item in conjunction with information identifying a content-providing user from whom the content item was received, information identifying one or more content publishers to which the content item is to be provided, information describing one or more performance metrics to be tracked and the times during which the performance metric(s) are to be tracked, targeting criteria associated with the content item, information describing a date range and a time of day within the date range during which the content item may be presented, etc. In the above example, the online system may store the content item among additional content items received from other content-providing users of the online system.

The online system may track various performance metrics (e.g., impression performance metrics, revenue performance metrics, interaction performance metrics, etc.) for a content item using one or more tracking mechanisms (e.g., tracking pixels or cookies). A tracking mechanism allows the online system to track a performance metric for a content item by collecting various types of information describing the performance metric. For example, to track impression performance metrics and interaction performance metrics for a content item, a tracking mechanism may collect information describing each impression of the content item and information describing each click on the content item, respectively. As an additional example, to track revenue performance metrics for a content item, a tracking mechanism may collect information describing each purchase associated with the content item.

In some embodiments, the online system may track a performance metric for a content item using a tracking pixel embedded into the content item or into a web page associated with the content item. For example, a tracking pixel embedded into a content item may track impression performance metrics for the content item by collecting information describing requests to present the content item to various individuals at multiple content publishers. As an additional example, a tracking pixel embedded into a purchase confirmation page associated with a content item may track revenue performance metrics for the content item by collecting information describing purchases associated with the content item that were made by various individuals.

In some embodiments, the online system may generate and embed code corresponding to a tracking pixel into a content item or into a page associated with the content item. The code corresponding to a tracking pixel allows information describing a request to present a content item or a page associated with the content item to be communicated to the online system upon receiving a request to present the content item or the page into which the code is embedded. For example, to track impressions of a content item, the online system may generate code corresponding to a tracking pixel and embed the code into the content item. In this example, when a web server at the online system receives a request to present the content item at a content publisher, the web server also may receive various types of information describing the request via the tracking pixel (e.g., a client device identifier, such as an IP address, associated with a client device from which the request is being received, information identifying the content publisher at which the content item is to be presented, a date/time of the request, etc.). As an additional example, to track clicks on a content item, the online system may generate code corresponding to a tracking pixel and embed the code into a landing page for a link included in the content item. In this example, when a web server at the online system receives a request to present the landing page to an individual, the web server also may receive an IP address associated with a client device from which the request is being received, information describing the content publisher at which the content item was presented, a date/time of the request, etc.

In various embodiments, the online system also may track performance metrics for a content item using cookies. For example, tracking cookies may be used to track impression performance metrics for a content item by collecting information describing requests to present the content item to the same individual at multiple content publishers. When a server at the online system receives a request associated with a content item (e.g., a request to present the content item to an individual), the online system may store a cookie in a browser at a client device from which the request was received. A cookie may record various types of information describing actions that may be performed by an individual across multiple websites. For example, a cookie may store information identifying a content publisher at which a particular content item was presented, user identifying information associated with an individual to whom the content item was presented (e.g., based on an IP address, on a user agent, or on other information that is unique to the individual), a date/time of the presentation, information describing a purchase of goods/services featured in the content item, a geographic location of the individual to whom the content item was presented (e.g., based on GPS coordinates of the individual's client device), etc.

The online system subsequently may receive information stored in a cookie, which may include information describing a performance metric for a content item. For example, information received from a cookie may describe impression performance metrics for a content item (e.g., when the content item was previously presented to an individual, information identifying one or more content publishers at which the content item was previously presented to the individual, etc.). In this example, information received from the cookie also may describe interaction performance metrics for the content item (e.g., when the individual clicked on the content item, information identifying a content publisher that presented the content item on which the individual clicked, etc.).

To track a performance metric for a content item using a cookie, the online system may set the cookie to store and to return information describing the performance metric to the online system. For example, upon receiving a request to present a content item at a content publisher, the online system may set a cookie by sending instructions to a browser on a client device from which the request was received to store information describing the request in the cookie and to send the cookie back in conjunction with future requests communicated to a server at the online system. In this example, upon receiving a request to present content on the same client device at a different content publisher, the online system also may receive the cookie from the browser.

Upon receiving information describing a performance metric collected using a tracking mechanism, the information may be stored in the online system. The information describing a performance metric for a content item may include information identifying a content publisher that presented the content item. For example, if a content item was presented to various individuals by multiple content publishers, information describing impression performance metrics for each content publisher that presented the content item may indicate an identity of the content publisher (e.g., a name or other unique identifier associated with the content publisher). Information describing a performance metric also may describe individuals associated with the performance metric. In the above example, the impression performance metrics for each content publisher also may indicate a client device identifier or other user identifying information associated with individuals presented with the content item. Furthermore, information describing a performance metric also may include dates or times associated with the performance metric (e.g., a date and time that a content item was presented to a particular individual by a particular content publisher) or any other suitable types of information associated with the performance metric.

In some embodiments, the online system may maintain a table or a log describing a performance metric for a content item, in which each entry in the table or the log corresponds to information describing a presentation of the content item by a content publisher and/or the performance of an action in association with the presentation of the content item by the content publisher. For example, the online system may maintain a table describing impression performance metrics for a content item presented by a content publisher, in which each entry in the table corresponds to information describing a presentation of the content item to an individual by the content publisher. In this example, the online system may add a new entry to the table each time information describing a presentation of the content item to an individual by the content publisher is received at the online system.

The online system may identify one or more online system users included among the individuals who were presented with a content item by a content publisher and/or who performed an action in association with being presented with the content item by the content publisher. The online system users may be identified from the individuals based on information collected using a tracking mechanism and on information maintained in the online system. For example, the online system may compare user identifying information that is received using a tracking mechanism to user identifying information maintained in the online system that is stored in association with a user profile of each online system user. In this example, the online system may identify an individual presented with a content item as an online system user based on the comparison (e.g., by identifying a user profile of an online system user that is associated with an IP address or other user identifying information that matches the user identifying information that is received using the tracking mechanism). In some embodiments, the online system also may identify one or more online system users included among the individuals who were presented with a content item by a content publisher and/or who performed an action in association with being presented with the content item by the content publisher based on a date/time of the presentation and/or the performance of the action. For example, the online system may identify a set of individuals who were presented with a content item by a content publisher during a particular time range (e.g., within the last week) and identify one or more online system users included among this set of individuals.

In embodiments in which a tracking mechanism is used to track performance metrics associated with actions performed by individuals in association with being presented with a content item by a content publisher (e.g., interaction performance metrics or revenue performance metrics), the online system may identify the individuals by comparing user identifying information collected using multiple tracking mechanisms. For example, the online system may identify an individual associated with a client device as an individual who made a purchase in association with being presented with a content item if a client device identifier associated with the client device received using a tracking pixel embedded into a purchase confirmation page matches a client device identifier received using a different tracking pixel embedded into the content item.

In some embodiments, the online system also may identify individuals who performed actions in association with being presented with a content item by a content publisher by comparing dates/times at which user identifying information was collected using different tracking pixels. For example, the online system may compare a time at which a server at the online system received a request to present a purchase confirmation page to an individual using a tracking pixel embedded into the purchase confirmation page to a time at which the server received a request to present a content item to the individual at a content publisher using a different tracking pixel embedded into the content item. In this example, the online system may identify the individual as an individual who made a purchase in association with being presented with the content item by the content publisher if the server received the request to present the purchase confirmation page to the individual after and within a threshold amount of time at which the server received the request to present the content item to the individual at the content publisher. Furthermore, in the above example, if the content item was presented to the same individual by multiple content publishers, the online system may compare a time at which the server received the request to present the purchase confirmation page to the individual to a time at which the server received a request to present the content item to the individual at each content publisher. In this example, the online system may identify the individual as an individual who made a purchase in association with being presented with the content item by a particular content publisher if the time at which the server received the request to present the content item to the individual at the content publisher is prior to and closest to the time at which the server received the request to present the purchase confirmation page to the individual.

In some embodiments, upon identifying the online system users included among the individuals who were presented with a content item by a content publisher and/or who performed an action in association with being presented with the content item by the content publisher, the online system may communicate a request for information to these users. For example, the online system may communicate (e.g., via email or instant message) a poll or a survey to the online system users inquiring whether the users recall being presented with a content item or performing an action in association with being presented with the content item. Upon receiving information from an online system user in response to the request for information, the online system may store this information as an attribute associated with the user. The online system subsequently may retrieve this attribute, as well as additional attributes maintained in the online system associated with each of the online system users included among the individuals who were presented with the content item by a content publisher and/or who performed an action in association with being presented with the content item by the content publisher.

Once the online system has identified one or more users of the online system included among the individuals who were presented with a content item by a content publisher and/or who performed an action in association with being presented with the content item by the content publisher, the online system may retrieve information maintained in the online system describing various attributes associated with the online system users. In some embodiments, the attributes associated with the users may include interests, demographic information, actions performed by the users in the online system or in a third-party system, or any other suitable types of information that may be stored in association with a user profile of an online system user. For example, the online system may retrieve information stored in association with a user profile of each online system user that describes the user's hobbies, occupation, and hometown.

Based on the attributes associated with the online system users included among the individuals who were presented with a content item by a content publisher and/or who performed an action in association with being presented with the content item by the content publisher, the online system may determine a number of online system users having each of the attributes. For example, the online system may determine a number of online system users included among the individuals who were presented with a content item by a content publisher and/or who performed an action in association with being presented with the content item by the content publisher who are of a particular age group and/or who live in a particular geographic region. In some embodiments, the online system may determine a percentage or a proportion of online system users having each of the attributes. For example, the online system may determine a percentage or a ratio of online system users included among the individuals who were presented with a content item by a content publisher and/or who performed an action in association with being presented with the content item by the content publisher who recalled being presented with the content item two weeks after being presented with the content item. As an additional example, the online system may determine a ratio of online system users included among the individuals who attended a particular school or who enjoy playing a particular sport.

In response to determining the number of online system users included among the individuals having each of the attributes, the online system may extrapolate a set of the individuals who also have each of the attributes. The set of individuals extrapolated by the online system represents a number of individuals who are likely to have an attribute based on a number of online system users included among the individuals who have the same attribute. For example, based on a number of online system users included among individuals who were presented with a given content item by a given content publisher and a number of these online system users who have a particular attribute, the online system may determine a percentage of the online system users having the attribute. In this example, the online system may use this percentage to extrapolate a set of the individuals who also are likely to have the attribute.

In some embodiments, the online system may extrapolate a set of the individuals having an attribute based on a ratio or on a percentage of users of the online system included among the individuals who have the attribute, such that the ratio or the percentage of individuals included in the set is proportional to the ratio or the percentage of the online system users having the attribute. For example, if 53% of online system users who are presented with a content item by a content publisher and who make a purchase in association with being presented with the content item are single, female, between the ages of 21 and 35, and have an annual income between $40,000 and $80,000, the online system may extrapolate that 53% of the individuals who are presented with the content item by the content publisher and who make a purchase in association with being presented with the content item also are single, female, between the ages of 21 and 35, and have an annual income between $40,000 and $80,000. As an additional example, the online system may determine that three out of 10 online system users who are presented with a content item by a content publisher and who subsequently visit a physical location associated with the content item (e.g., by checking-in to the physical location with a mobile device) are married, male, between the ages of 36 and 45, and live in a household with pets, the online system may extrapolate that three out of 10 of the individuals who are presented with the content item by the content publisher and who visit the physical location associated with the content item also are married, male, between the ages of 36 and 45, and live in a household with pets.

In some embodiments, the online system also may extrapolate the set of individuals having each attribute based at least in part on a sampling method. For example, the online system may randomly sample the online system users identified from the individuals presented with a content item by a content publisher and determine a ratio or a percentage of the randomly sampled users associated with each of various age ranges and geographic locations. In this example, the online system may then extrapolate a set of individuals who belong to each of the age ranges and who are located in each of the geographic locations based on the ratio or on the percentage of the sampled users associated with each of the age ranges and geographic locations. The online system may use various types of sampling methods to extrapolate the set of individuals having an attribute, such as simple random sampling, stratified sampling, cluster sampling, or any other suitable sampling method.

In various embodiments, the online system may select a sampling method that de-biases the online system users included among the individuals used to extrapolate the set of individuals who have an attribute (e.g., if there is a known difference between the online system users presented with the content item by a content publisher and the individuals presented with the content item by the content publisher). For example, suppose it is known that a tracking mechanism failed to track about half of the clicks on a content item by individuals using the Google Chrome Web browser who were presented with the content item by a content publisher, but was successful at tracking all clicks on the content item by online system users, regardless of the browser used. In this example, the online system may select a sampling method, such as a stratified sampling method or a cluster sampling method, to sample the online system users who clicked on the content item after being presented with the content item by the content publisher, in which the online system users are divided into strata or clusters based on the browser they used when they clicked on the content item. Continuing with this example, since the tracking mechanism failed to track about half of the clicks by the individuals using the Google Chrome Web browser, the online system may sample an equal number of online system users from each stratum or cluster, but double the number of users sampled from the stratum or cluster including users who used this browser when they clicked on the content item. In this example, the online system may then extrapolate the set of individuals having each of one or more attributes based on attributes associated with the sampled users.

Once the online system has extrapolated a set of individuals having each attribute, the online system may generate analytics associated with a content item. In some embodiments, the analytics may include various performance metrics describing the individuals who were presented with a content item by one or more content publishers and/or who performed an action in association with being presented with the content item by the content publishers. For example, the online system may communicate analytics to an advertiser that include impression performance metrics for a content item presented to individuals by each of multiple content publishers, in which the impression performance metrics for each content publisher indicate the number of individuals who were presented with the content item by the content publisher. In this example, the analytics also may indicate the number or percentage of online system users included among the individuals. Furthermore, in this example, the analytics may break down the impression performance metrics by each attribute associated with the individuals and the online system users (e.g., by gender, client device used to access the content item, geographic location, recollection of being presented with the content item, etc.).

The analytics associated with a content item may be communicated to a user of the online system associated with the content item. For example, the analytics may be communicated to an advertiser or other content-providing user who provided the content item to the online system. In some embodiments, the online system may include the analytics in a report that may be communicated to the user of the online system. For example, a report may include various charts, graphs, and insights based on the analytics generated by the online system that are associated with a content item.

Information maintained in the online system describing attributes associated with online system users may be exported to a content publisher to reduce a lag time between the presentation of a content item by the content publisher and/or the performance of an action in association with the presentation of the content item by the content publisher and communication of analytics associated with the content item to an online system user associated with the content item. In such embodiments, the online system may obfuscate user identifying information associated with online system users prior to exporting the information to the content publisher. For example, the online system may encrypt various types of user identifying information by using a cryptographic hash function to create hashes of users' email addresses and first and last names before providing the information to the content publisher. The content publisher may then extrapolate a set of individuals associated with each of various attributes, as described above. Additionally, the content publisher may generate various analytics associated with the content item and communicate them to the online system user, as described above.

The online system user to whom the analytics are communicated may use the analytics to more closely tailor a content item to individuals who may be presented with the content item by each of the content publishers. For example, if the online system user is an advertiser for an appliance store who provided a content item to the online system, analytics provided by the online system may indicate that a majority of individuals presented with the content item by a first content publisher are homeowners while a majority of individuals presented with the content item by a second content publisher are not homeowners, but are college students. In this example, after receiving the analytics associated with the advertisement, the advertiser may provide an advertisement to the first content publisher that features appliances that homeowners are likely to purchase (e.g., ovens, washers, and dryers) while the advertiser may provide a different advertisement to the second content publisher that features appliances that college students are likely to purchase (e.g., microwaves and mini refrigerators).

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIGS. 3A and 3B are interaction diagrams of a method for generating analytics for a content item presented to individuals by one or more content publishers based on attributes extrapolated from online system users, in accordance with an embodiment.

FIG. 4 is an example of analytics describing one or more performance metrics for a content item, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

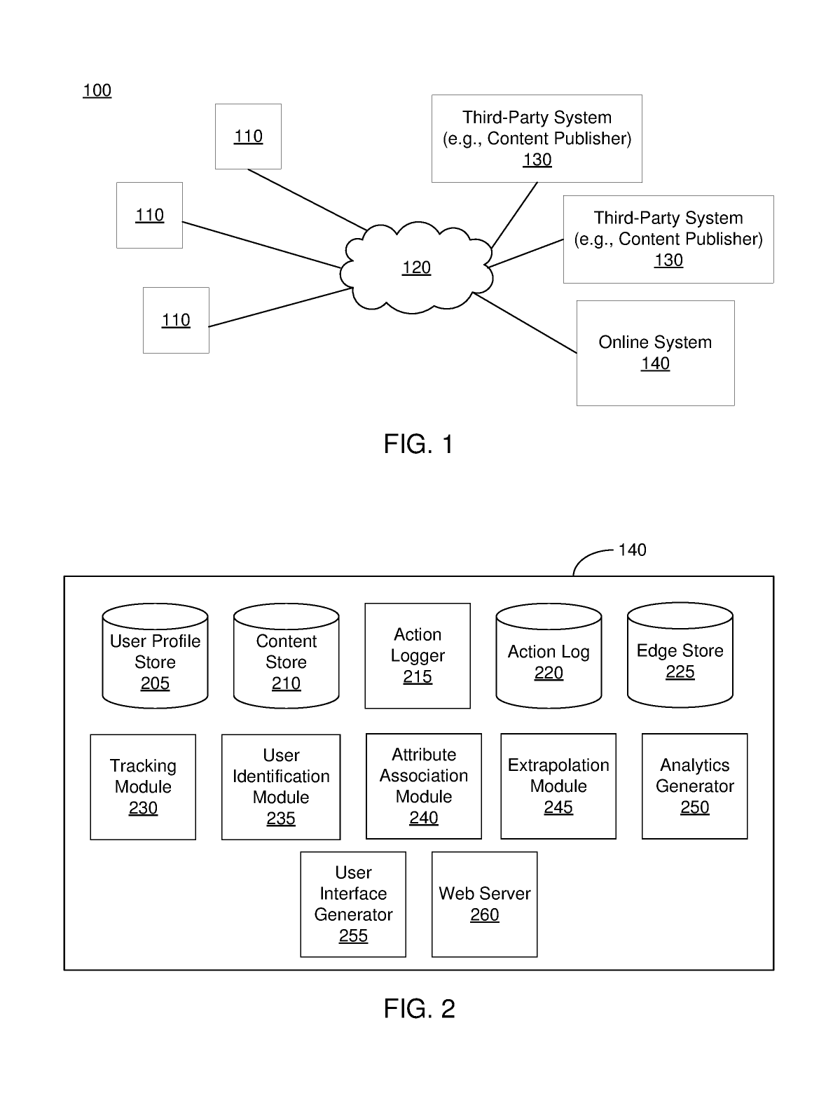

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

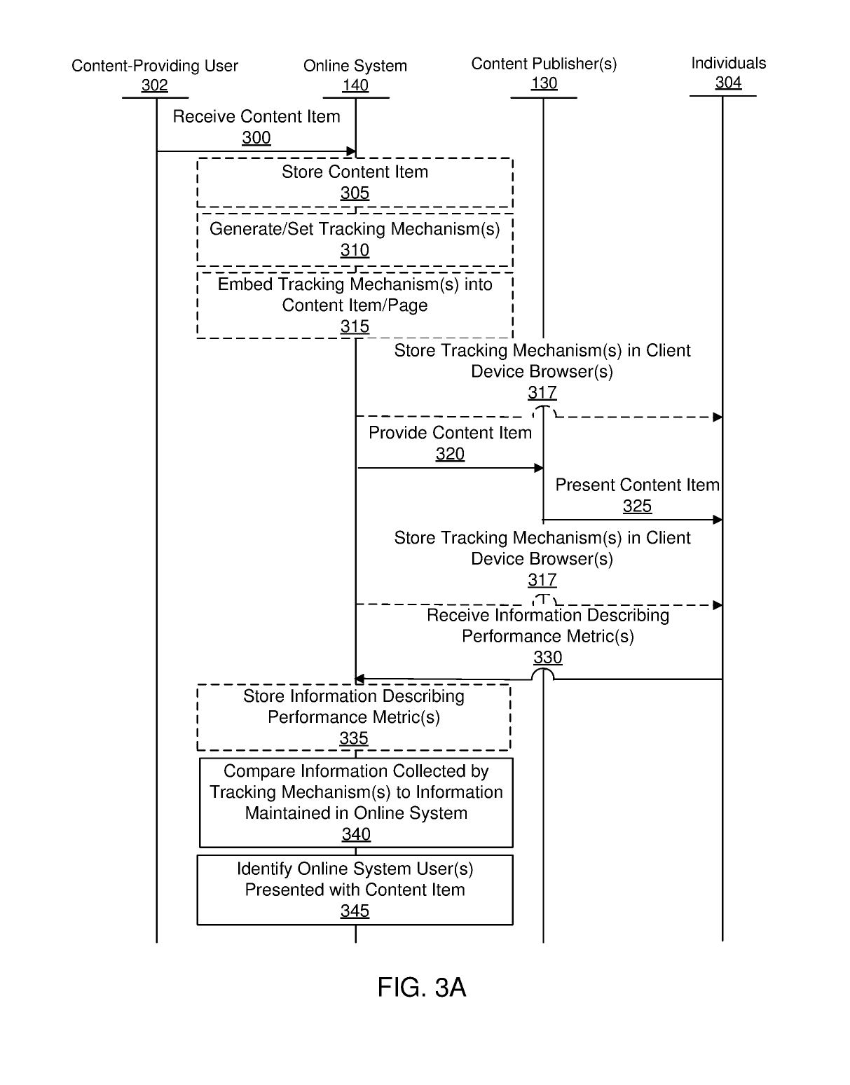

One or more third-party systems 130 may be coupled to the network 120 for communicating with the online system 140, which is further described below in conjunction with FIG. 2. In one embodiment, a third-party system 130 is an application provider communicating information describing applications for execution by a client device 110 or communicating data to client devices 110 for use by an application executing on the client device 110. In other embodiments, a third-party system 130 (e.g., a content publisher) provides content or other information for presentation via a client device 110. A third-party system 130 also may communicate information to the online system 140, such as advertisements, content, or information about an application provided by the third-party system 130.

FIG. 2 is a block diagram of an architecture of the online system 140. The online system 140 shown in FIG. 2 includes a user profile store 205, a content store 210, an action logger 215, an action log 220, an edge store 225, a tracking module 230, a user identification module 235, an attribute association module 240, an extrapolation module 245, an analytics generator 250, a user interface generator 255, and a web server 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more user attributes for the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

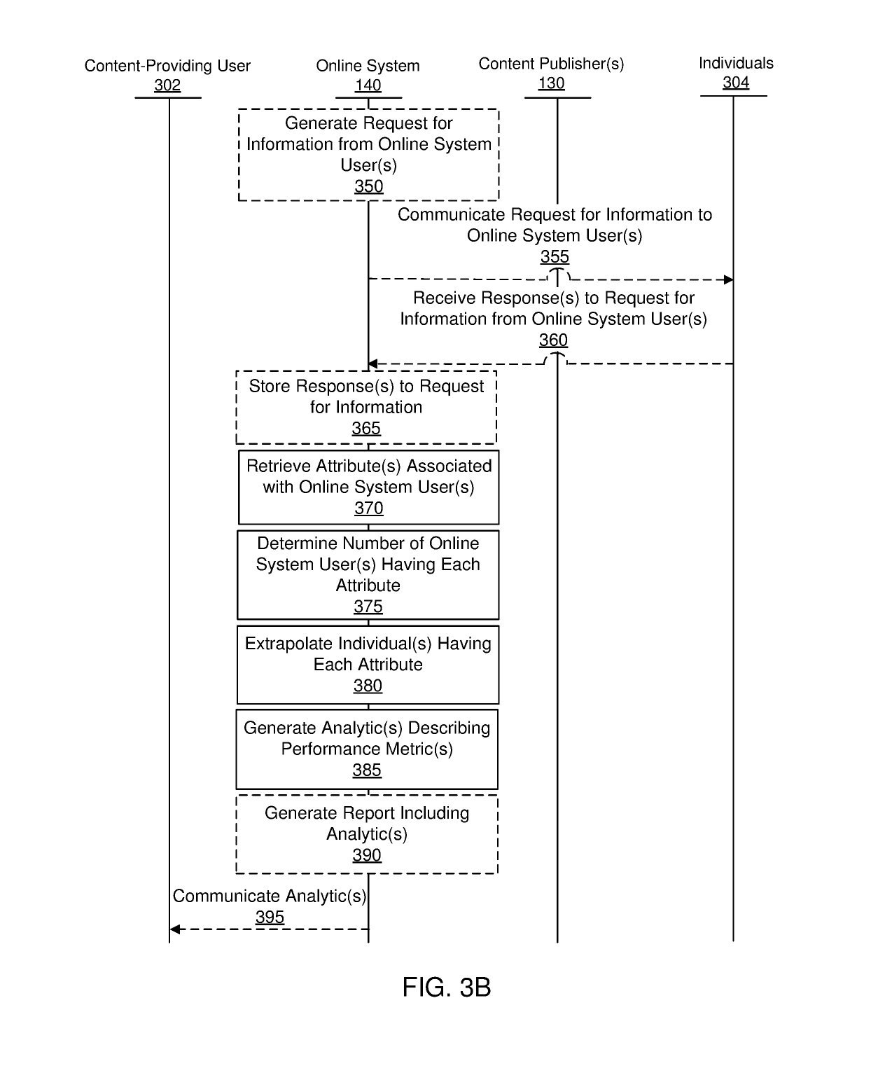

In some embodiments, the user profile store 205 stores (e.g., as shown in step 365 of FIG. 3B) responses to requests for information from online system users as attributes for the corresponding users in conjunction with the users' profiles. For example, the online system 140 may communicate a poll, a questionnaire, or a survey to an online system user via email or instant message inquiring whether the user recalls being presented with a content item or performing an action in association with being presented with the content item. In this example, the online system 140 may store information describing the user's response to the request for information as an attribute associated with the user's profile in the user profile store 205.

While user profiles in the user profile store 205 are frequently associated with individuals, allowing individuals to interact with each other via the online system 140, user profiles also may be stored for entities such as businesses or organizations. This allows an entity to establish a presence in the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores (e.g., as shown in step 305 of FIG. 3A) objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

In some embodiments, the content store 210 stores various types of information associated with a content item received from a content-providing user of the online system 140. For example, the content store 210 may store a content item in conjunction with information identifying a content-providing user from whom the content item was received. Information associated with a content item received from a content-providing user of the online system 140 may include information identifying one or more content publishers 130 to which the content item is to be provided and/or information describing one or more performance metrics to be tracked. For example, the content store 210 may store a content item in conjunction with the names of various content publishers 130 specified by the content-providing user to which the content item is to be provided and information describing various interaction performance metrics to be tracked during a particular time period. Information associated with a content item received from a content-providing user of the online system 140 also may include information describing one or more time intervals during which the content item is to be presented to online system users or to other individuals. For example, the content store 210 may store a content item in conjunction with information describing a date range (e.g., June and July of a particular year) and a time of day within the date range (e.g., Saturday and Sunday between 10:00 AM and 8:00 PM) during which the content item may be presented.

The content store 210 may store (e.g., as shown in step 335 of FIG. 3A) information describing various performance metrics (e.g., revenue performance metrics, interaction performance metrics, impression performance metrics, etc.) associated with various content items. Information describing a performance metric for a content item may include information identifying a content publisher 130 that presented the content item. For example, if a content item was presented to various individuals by multiple content publishers 130, information describing impression performance metrics for each content publisher 130 that presented the content item may indicate an identity of the content publisher 130, such as a name of the content publisher 130, an identification number of the content publisher 130, or any other unique identifier that may be used to identify the content publisher 130. Information describing a performance metric may describe individuals associated with the performance metric. In the above example, the impression performance metrics for each content publisher 130 also may indicate a client device identifier or other user identifying information associated with individuals presented with the content item. Furthermore, information describing a performance metric also may include dates or times associated with the performance metric. For example, impression performance metrics for a content item may indicate a date and time that the content item was presented to an individual by a content publisher 130. Information describing a performance metric also may describe any other suitable types of information associated with the performance metric. For example, information describing a revenue performance metric may indicate each good/service associated with a content item that was purchased, an amount of the purchase, a form of payment used, etc.

The content store 210 may store information describing each performance metric for a content item in association with an object representing the content item. In some embodiments, the online system 140 may maintain a table or a log describing a performance metric for a content item, which is stored in association with an object representing the content item. In such embodiments, each entry in the table or the log corresponds to information describing a presentation of the content item by a content publisher 130 and/or the performance of an action in association with the presentation of the content item by the content publisher 130. For example, the online system 140 may maintain a table describing impression performance metrics for a content item presented by a content publisher 130, in which each entry in the table corresponds to information describing a presentation of the content item to an individual by the content publisher 130. In this example, the online system 140 may add a new entry to the table each time information describing an impression of the content item for an individual at the content publisher 130 is received (e.g., by the web server 260) at the online system 140. In this example, the table may be stored in the content store 210 in association with an object representing the content item.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored (e.g., as shown in step 360 of FIG. 3B) in the action log 220.

The action log 220 may be used by the online system 140 to track user actions in the online system 140, as well as actions in the third-party system 130 that communicate information to the online system 140. Users may interact with various objects in the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the online system 140 as well as with other applications operating in the online system 140. In some embodiments, data from the action log 220 is used to infer interests or preferences of a user, augmenting the interests included in the user's user profile and allowing a more complete understanding of user preferences.

The action log 220 also may store user actions taken on a third-party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third-party system 130, including webpage viewing histories, advertisements that were engaged, purchases made, and other patterns from shopping and buying. Additionally, actions a user performs via an application associated with a third-party system 130 and executing on a client device 110 may be communicated to the action logger 215 for storing in the action log 220 by the application for recordation and association with the user by the online system 140.

In one embodiment, the edge store 225 stores information describing connections between users and other objects in the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page in the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The tracking module 230 may generate (e.g., as shown in step 310 of FIG. 3A) one or more tracking mechanisms (e.g., tracking pixels) used to track various performance metrics (e.g., impression performance metrics, revenue performance metrics, interaction performance metrics, etc.) for a content item. A tracking mechanism allows the online system 140 to track a performance metric for a content item by collecting various types of information describing the performance metric. For example, to track impression performance metrics and interaction performance metrics for a content item, a tracking mechanism may collect information describing each impression of the content item and information describing each click on the content item, respectively. As an additional example, to track revenue performance metrics for a content item, a tracking mechanism may collect information describing each purchase associated with the content item.

In some embodiments, a tracking mechanism generated by the tracking module 230 is a tracking pixel. For example, the tracking module 230 may generate code corresponding to a tracking pixel that is a transparent 1×1 pixel image (e.g., a GIF, a JPEG, or a PNG file). The code corresponding to a tracking pixel allows information describing a request to present a content item or a page associated with the content item to be communicated to the online system 140. For example, a tracking pixel embedded into a content item may track impression performance metrics for the content item by collecting information describing requests to present the content item to various individuals at multiple content publishers 130. As an additional example, a tracking pixel embedded into a purchase confirmation page associated with a content item may track revenue performance metrics for the content item by collecting information describing purchases associated with the content item that were made by various individuals.

In some embodiments, the tracking module 230 may set (e.g., as shown in step 310 of FIG. 3A) a tracking mechanism, such as a cookie, to track performance metrics for a content item. For example, tracking cookies may be used to track impression performance metrics for a content item by collecting information describing requests to present the content item to the same individual at multiple content publishers 130. To track a performance metric for a content item using a cookie, the tracking module 230 may set the cookie to store and to return information describing the performance metric to the online system 140. For example, upon receiving a request to present a content item at a content publisher 130, the tracking module 230 may set a cookie by sending instructions to a browser on a client device 110 from which the request was received to store information describing the request in the cookie and to send the cookie back in conjunction with future requests communicated to a server (e.g., the web server 260) at the online system 140. In this example, upon receiving a request to present content on the same client device 110 at a different content publisher 130, the online system 140 also may receive the cookie from the browser.

In some embodiments, the tracking module 230 may embed (e.g., as shown in step 315 of FIG. 3A) a tracking mechanism into a content item to track information describing various performance metrics for the content item. For example, to track impressions of a content item, the tracking module 230 may embed code corresponding to a tracking pixel into the content item. In this example, when a server (e.g., the web server 260) at the online system 140 receives a request to present the content item at a content publisher 130, the server also may receive various types of information describing the request via the tracking pixel (e.g., a client device identifier, such as an IP address, associated with a client device 110 from which the request is being received, information identifying the content publisher 130 at which the content item is to be presented, a date/time of the request, etc.).

In various embodiments, the tracking module 230 also may embed a tracking mechanism into a web page associated with a content item. For example, to track clicks on a content item, the tracking module 230 may embed code corresponding to a tracking pixel into a landing page for a link included in the content item. In this example, when a server (e.g., the web server 260) at the online system 140 receives a request to present the landing page to an individual, the server also may receive an IP address associated with a client device 110 from which the request is being received, information describing the content publisher 130 at which the content item was presented, a date/time of the request, etc. As an additional example, to track conversions (e.g., website registrations, purchases, etc.) associated with a content item, the tracking module 230 may embed code corresponding to a tracking mechanism into a web page associated with the content item (e.g., a registration confirmation page, a checkout confirmation page, etc.). In this example, when a server (e.g., the web server 260) at the online system 140 receives a request to present the web page to an individual, the server also may receive an IP address associated with a client device 110 from which the request is being received, information describing the goods purchased/services subscribed, a date/time of the request, etc.

In some embodiments, the tracking module 230 may store (e.g., as shown in step 317 of FIG. 3A) one or more tracking mechanisms in a browser on a client device 110. For example, when a server (e.g., the web server 260) at the online system 140 receives a request associated with a content item (e.g., a request to present the content item to an individual), the tracking module 230 may store a cookie in a browser at a client device 110 from which the request was received. A cookie may record various types of information describing actions that may be performed by an individual across multiple websites. For example, a cookie may store information identifying a content publisher 130 at which a particular content item was presented, user identifying information associated with an individual to whom the content item was presented (e.g., based on an IP address, on a user agent, or on other information that is unique to the individual), a date/time of the presentation, information describing a purchase of goods/services featured in the content item, a geographic location of the individual to whom the content item was presented (e.g., based on GPS coordinates of the individual's client device 110), etc. As described above, once a cookie has been set to store information describing the request and to be sent back to the online system 140 in conjunction with future requests communicated to a server (e.g., the web server 260) at the online system 140, upon receiving a request to present content on the same client device 110 at a different content publisher 130, the online system 140 may receive the cookie from the browser. The functionality of the tracking module 230 is further described below in conjunction with FIG. 3A).

The user identification module 235 compares (e.g., as shown in step 340 of FIG. 3A) information collected using a tracking mechanism to information maintained in the online system 140. In some embodiments, the user identification module 235 compares user identifying information collected using a tracking mechanism to user identifying information maintained in the online system 140. For example, the user identification module 235 accesses information previously received using a tracking mechanism that describes the presentation of a content item/the performance of actions in association with the presentation of the content item (e.g., from the content store 210, from the action log 220 and/or from the edge store 225). In this example, the user identification module 235 then compares an IP address associated with a client device 110 included in this information with an IP address stored in association with each user profile of various online system users (e.g., in the user profile store 205).

In embodiments in which a tracking mechanism is embedded into a page associated with a content item to track performance metrics associated with actions performed by individuals in association with being presented with the content item by a content publisher 130 (e.g., interaction performance metrics or revenue performance metrics), the user identification module 235 may compare user identifying information collected using multiple tracking mechanisms. For example, the user identification module 235 may compare a client device identifier collected using a tracking pixel embedded into a content item to a client device identifier collected using a different tracking pixel embedded into a purchase confirmation page associated with the content item. In some embodiments, the user identification module 235 also may compare dates/times at which user identifying information collected using different tracking mechanisms was received (e.g., if the content item was presented to the same individual by multiple content publishers 130), as further described below.

The user identification module 235 also identifies (e.g., as shown in step 345 of FIG. 3A) online system users included among individuals who were presented with a content item by a content publisher 130 and/or who performed an action in association with being presented with the content item by the content publisher 130. The user identification module 235 may identify an online system user based on a comparison of information collected using a tracking mechanism to information maintained in the online system 140. For example, the user identification module 235 may identify an individual presented with a content item as an online system user if a user profile of the online system user is associated with an IP address that matches an IP address that was collected using a tracking mechanism embedded into the content item.

In some embodiments, the user identification module 235 also may identify one or more online system users included among the individuals who were presented with a content item by a content publisher 130 and/or who performed an action in association with being presented with the content item by the content publisher 130 based in part on a date/time of the presentation/the performance of the action. For example, the user identification module 235 may identify a set of individuals who were presented with a content item by a content publisher 130 during a particular time range (e.g., within the last week). In this example, the user identification module 235 may then identify one or more online system users included among this set of individuals.

In some embodiments, a content publisher 130 may identify online system users included among the individuals who were presented with a content item by the content publisher 130 and/or who performed an action in association with being presented with the content item by the content publisher 130. In such embodiments, information maintained in the online system 140 describing attributes associated with online system users may be exported to the content publisher 130. Furthermore, in such embodiments, the online system 140 may obfuscate user identifying information associated with online system users prior to exporting the information to the content publisher 130. For example, the online system 140 may encrypt various types of user identifying information by using a cryptographic hash function to create hashes of users' email addresses and first and last names before providing the information to the content publisher 130. The content publisher 130 may then identify online system users included among the individuals who were presented with a content item by the content publisher 130 and/or who performed an action in association with being presented with the content item by the content publisher 130, as described above.

In embodiments in which a tracking mechanism is embedded into a page associated with a content item to track actions performed by individuals in association with being presented with the content item by a content publisher 130, the user identification module 235 may identify the individuals based on comparisons of information collected using multiple tracking mechanisms. For example, the user identification module 235 may identify an individual associated with a client device 110 as an individual who made a purchase in association with being presented with a content item if a client device identifier collected using a tracking pixel embedded into the content item matches a client device identifier collected using a different tracking pixel embedded into a purchase confirmation page associated with the content item. The user identification module 235 also may identify such individuals based on a comparison of dates/times at which information was collected using multiple tracking mechanisms. In the above example, the user identification module 235 may identify the individual as an individual who made a purchase in association with being presented with the content item if a server (e.g., the web server 260) at the online system 140 received a request to present a purchase confirmation page to the individual after and within a threshold amount of time at which the server received a request to present the content item to the individual at the content publisher 130.

In embodiments in which a content item was presented to the same individual by multiple content publishers 130, the user identification module 235 may identify the individual as an individual who performed an action in association with being presented with the content item by a particular content publisher 130. In such embodiments, the user identification module 235 may identify the individual based on a comparison of a date/time at which information was collected using a tracking pixel embedded into the content item presented by each content publisher 130 to a date/time at which information was collected using a tracking pixel embedded into a page associated with the content item. For example, the user identification module 235 may identify an individual as an individual who made a purchase in association with being presented with an advertisement by a particular content publisher 130 if a server (e.g., the web server 260) at the online system 140 received a request to present the advertisement to the individual at the content publisher 130 at a time that is prior to and closest to the time at which the server received a request to present the purchase confirmation page to the individual. The functionality of the user identification module 235 is further described below in conjunction with FIG. 3A.

The attribute association module 240 may retrieve (e.g., as shown in step 370 of FIG. 3B) various attributes associated with online system users maintained in the online system 140. Examples of attributes that may be associated with an online system user include demographic information (e.g., age, gender, income level, geographic location, etc.), hobbies/interests, actions performed by the user internal or external to the online system 140, connections established between the user and other users or objects maintained in the online system 140, etc. For example, the attribute association module 240 may retrieve an age, a gender, an occupation, one or more hobbies/interests, a geographic location, and any other information that may be stored in association with a user profile of an online system user from the user profile store 205. As an additional example, the attribute association module 240 may retrieve information stored in association with edges between a user of the online system 140 and an additional user of the online system 140 from the edge store 225. In this example, the information stored in association with the edges may describe a relationship between the users, communications sent between the users in the online system 140, etc. As yet another example, the attribute association module 240 may retrieve information describing actions performed by an online system user in the online system 140 (e.g., expressing a preference for a content item, joining a group, etc.) from the action log 220.

The attribute association module 240 also may determine (e.g., as shown in step 375 of FIG. 3B) a number of online system users included among individuals who were presented with a content item by a content publisher 130 and/or who performed an action in association with being presented with the content item by the content publisher 130 who have a particular attribute. The attribute association module 240 may make this determination based on information maintained in the online system 140 associated with each of the online system users (e.g., information stored in the user profile store 205, in the action log 220, and/or in the edge store 225). For example, after retrieving various attributes associated with online system users included among individuals who were presented with a content item by a content publisher 130 and/or who performed an action in association with being presented with the content item by the content publisher 130 (e.g., from the user profile store 205), the attribute association module 240 may determine a number of the users who have a particular attribute (e.g., who recalled being presented with the content item one week after being presented with the content item and who live in a particular geographic region). In some embodiments, the attribute association module 240 may determine a percentage or a proportion of online system users having a particular attribute. In the above example, the attribute association module 240 may determine a percentage or a ratio of the online system users included among the individuals who have the particular attribute.

In embodiments in which a content publisher 130 identifies online system users included among the individuals who were presented with a content item by a content publisher 130 and/or who performed an action in association with being presented with the content item by the content publisher 130, the content publisher 130 may determine a number/a percentage of the online system users who have a particular attribute, as described above. The functionality of the attribute association module 240 is further described below in conjunction with FIG. 3B.

In response to determining (e.g., using the attribute association module 240) a number of online system users included among individuals having a particular attribute, the extrapolation module 245 may extrapolate (e.g., as shown in step 380 of FIG. 3B) a set of the individuals who also have the attribute. The number of individuals included in the set of individuals extrapolated by the extrapolation module 245 represents the number of individuals who are likely to have an attribute based on a number or on a percentage of online system users included among the individuals who have the attribute. For example, if a certain percentage of online system users included among individuals who were presented with a given content item by a given content publisher 130 have a particular attribute, the extrapolation module 245 may use this percentage to extrapolate a number of the individuals who were presented with the same content item by the same content publisher 130 who are likely to have the attribute.

In some embodiments, the extrapolation module 245 may extrapolate a set of the individuals having an attribute based on a ratio or on a percentage of users of the online system 140 included among the individuals who have the attribute, such that the ratio or the percentage of individuals included in the set is proportional to the ratio or the percentage of the online system users having the attribute. For example, if 23% of online system users who are presented with a content item by a content publisher 130 and who make a purchase in association with being presented with the content item are married, female, between the ages of 35 and 40, and have an income between $80,000 and $90,000, the extrapolation module 245 may extrapolate that 23% of the individuals who are presented with the content item by the content publisher 130 and who make a purchase in association with being presented with the content item also are married, female, between the ages of 35 and 40, and have an income between $80,000 and $90,000. As an additional example, the extrapolation module 245 may determine that two out of 10 online system users who are presented with a content item by a content publisher 130 and who subsequently visit a physical location associated with the content item (e.g., by checking-in to the physical location with a mobile device) are male, between the ages of 12 and 17, and live in an apartment, the extrapolation module 245 may extrapolate that two out of 10 of the individuals who are presented with the content item by the content publisher 130 and who visit the physical location associated with the content item also are male, between the ages of 12 and 17, and live in an apartment.

In some embodiments, the extrapolation module 245 also may extrapolate the set of individuals having an attribute based at least in part on a sampling method. For example, the extrapolation module 245 may randomly sample online system users identified from individuals presented with a content item by a content publisher 130 and determine a ratio or a percentage of the randomly sampled users associated with each of various age ranges and occupations. In this example, the extrapolation module 245 may then extrapolate a set of the individuals who belong to each of the age ranges and who have various occupations based on the ratio or on the percentage of the sampled users who belong to each of the age ranges and who have the occupations. The extrapolation module 245 may use various types of sampling methods to extrapolate a set of individuals having an attribute. Examples of such sampling methods include simple random sampling, stratified sampling, cluster sampling, etc.

In various embodiments, the extrapolation module 245 may select a sampling method that de-biases the online system users included among the individuals used to extrapolate a set of individuals having an attribute (e.g., if there is a known difference between the online system users presented with a content item by a content publisher 130 and the individuals presented with the content item by the content publisher 130). For example, suppose it is known that individuals presented with a content item by a content publisher 130 on a client device 110 running on the iOS 10 operating system failed to track about half of the impressions of the content item, but was successful at tracking all impressions of the content item achieved by online system users. In this example, the extrapolation module 245 may select a sampling method, such as a stratified sampling method or a cluster sampling method, to sample the online system users who were presented with the content item by the content publisher 130, in which the online system users are divided into strata or clusters based on the operating system running on the client devices 110 they used when they were presented with the content item. Continuing with this example, since the tracking mechanism failed to track about half of the impressions of the content item presented to individuals using client devices 110 running the iOS 10 operating system, the extrapolation module 245 may sample an equal number of online system users from each stratum or cluster, but double the number of users sampled from the stratum or cluster including users who used client devices 110 running this operating system when they were presented with the content item. In this example, the extrapolation module 245 may then extrapolate the set of individuals associated with each of one or more attributes based on attributes associated with the sampled users.

In embodiments in which a content publisher 130 determines a number of online system users included among the individuals who were presented with a content item by the content publisher 130 and/or who performed an action in association with being presented with the content item by the content publisher 130 who have a particular attribute, the content publisher 130 may extrapolate a set of the individuals who also have the attribute, as described above. The functionality of the extrapolation module 245 is further described below in conjunction with FIG. 3B.

The analytics generator 250 generates (e.g., as shown in step 385 of FIG. 3B) analytics associated with a content item. The analytics generated by the analytics generator 250 may include various performance metrics describing individuals who were presented with a content item by one or more content publishers 130 and/or who performed an action in association with being presented with the content item by the content publishers 130. For example, the analytics generator 250 generates various analytics that include impression performance metrics for individuals presented with a content item by each of multiple content publishers 130, in which the impression performance metrics for each content publisher 130 indicate the number of individuals who were presented with the content item by the content publisher 130 during a particular time period. In this example, the analytics also may indicate the number or percentage of online system users included among the individuals. Furthermore, in this example, the analytics may break down the impression performance metrics by each attribute associated with the individuals and the online system users (e.g., by gender, client device 110 used to access the content item, geographic location, recollection of being presented with the content item, etc.).

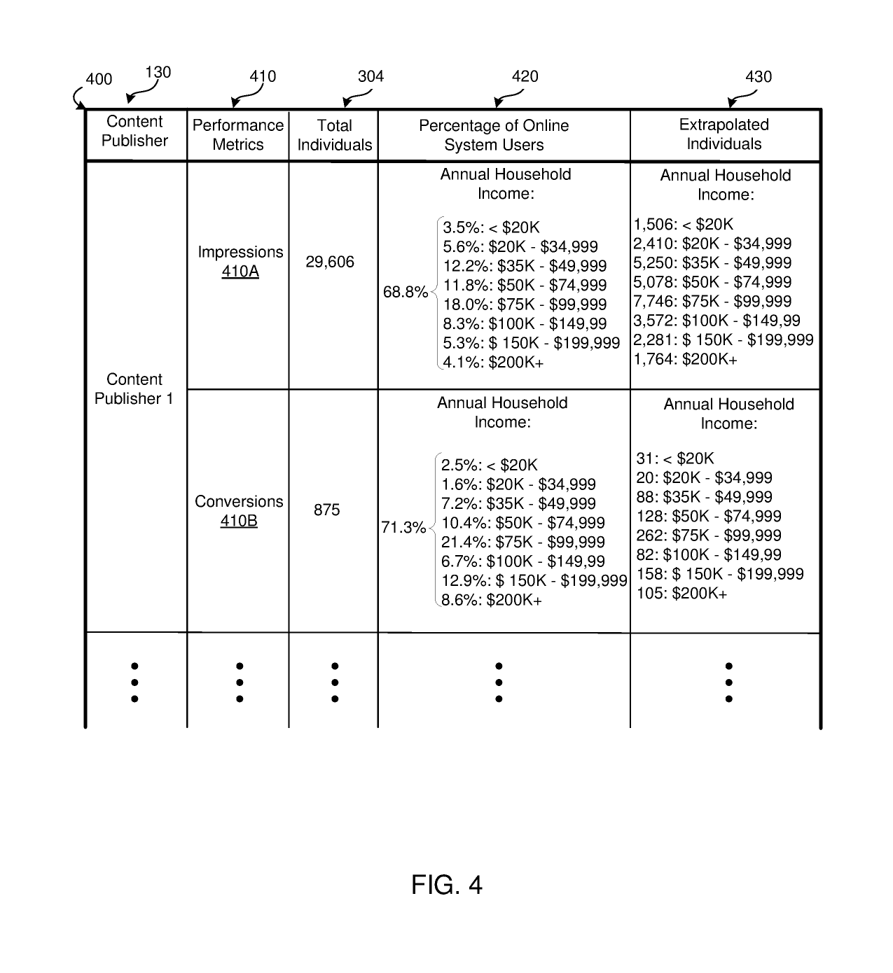

In embodiments in which a content publisher 130 extrapolates a set of the individuals who are associated with a particular attribute, the content publisher 130 also may generate the analytics describing the individuals who were presented with a content item by one or more content publishers 130 and/or who performed an action in association with being presented with a content item by the content publishers 130, as described above. The functionality of the analytics generator 250 is further described below in conjunction with FIGS. 3B and 4.

In some embodiments, the user interface generator 255 may generate (e.g., as shown in step 350 of FIG. 3B) a request for information from online system users identified (e.g., using the user identification module 235) as users included among the individuals who were presented with a content item by a content publisher 130 and/or who performed an action in association with being presented with the content item by the content publisher 130. For example, the user interface generator 255 may generate a poll or a survey inquiring whether online system users recall being presented with a content item and/or performing an action in association with being presented with the content item.

In some embodiments, the user interface generator 255 also may generate (e.g., as shown in step 390 of FIG. 3B) a report that includes various analytics associated with a content item. For example, a report generated by the user interface generator 255 may include various charts, graphs, and insights based on analytics that are associated with a content item. The functionality of the user interface generator 255 is further described below in conjunction with FIG. 3B.

The web server 260 links the online system 140 via the network 120 to the one or more client devices 110, as well as to the third-party system 130 and/or one or more third-party systems 130. The web server 260 serves web pages, as well as other content, such as JAVA®, FLASH®, XML and so forth. The web server 260 may receive and route messages between the online system 140 and the client device 110, for example, instant messages, queued messages (e.g., email), text messages, short message service (SMS) messages, or messages sent using any other suitable messaging technique. A user may send a request to the web server 260 to upload information (e.g., images or videos) that are stored in the content store 210. Additionally, the web server 260 may provide application programming interface (API) functionality to send data directly to native client device operating systems, such as IOS®, ANDROID™, WEBOS® or BlackberryOS.

Furthermore, the web server 260 may receive (e.g., as shown in step 330 of FIG. 3A) various types of information describing one or more performance metrics using a tracking mechanism. In some embodiments, the web server 260 may receive information stored in a cookie, which may include information describing a performance metric for a content item. For example, the web server 260 may receive information from a cookie, which may describe impression performance metrics for a content item (e.g., when the content item was previously presented to an individual, information identifying one or more content publishers 130 at which the content item was previously presented to the individual, etc.). In this example, information received from the cookie also may describe interaction performance metrics for the content item (e.g., when the individual clicked on the content item, information identifying a content publisher 130 that presented the content item on which the individual clicked, etc.). The web server 260 also may receive information describing one or more performance metrics via a tracking pixel. For example, when the web server 260 receives a request to present a content item at a content publisher 130, the web server 260 also may receive various types of information describing the request via a tracking pixel embedded into the content item (e.g., an IP address associated with a client device 110 from which the request is being received, information identifying the content publisher 130 at which the content item is to be presented, a date/time of the request, etc.).

### Generating Analytics for a Content Item Based on Extrapolated User Attributes

FIGS. 3A and 3B are interaction diagrams of a method for generating analytics for a content item presented to individuals by one or more content publishers based on attributes extrapolated from online system users. In other embodiments, the method may include different and/or additional steps than those shown in FIGS. 3A and 3B. Additionally, steps of the method may be performed in a different order than the order described in conjunction with FIGS. 3A and 3B.

The online system 140 may receive 300 a content item from a content-providing user 302 of the online system 140. For example, the online system 140 may receive 300 an advertisement from an advertiser or other content-providing user 302 of the online system 140. The content item may include various elements, including a title, an image, a video, text, a call to action (e.g., to click on the content item), a link to a landing page associated with the content item (e.g., a brand page at which a purchase associated with the content item may be made), etc.

The content item may be received 300 in conjunction with various types of information. In some embodiments, the content item may be received 300 in conjunction with information specified by the content-providing user 302 identifying one or more content publishers 130 to which the content item is to be provided and one or more performance metrics to be tracked. For example, the online system 140 may receive 300 the content item in conjunction with the names of various content publishers 130 to which the online system 140 is to provide the content item. The content item also may be received 300 in conjunction with targeting criteria describing online system users or other individuals 304 eligible to be presented with the content item (e.g., geographic locations associated with the online system users/individuals 304). For example, targeting criteria received 300 in conjunction with a content item are used to identify individuals 304 associated with a particular type of client device 110, individuals 304 who are using a particular browser, and individuals 304 in a particular geographic location (e.g., based on GPS coordinates of a client device 110 associated with the individuals 304) etc. as individuals 304 who are eligible to be presented with the content item. The content item also may be received 300 in conjunction with information describing one or more time intervals during which the content item is to be presented to online system users or to other individuals 304. For example, the content item may be received 300 in conjunction with information describing a date range (e.g., June and July of a particular year) and a time of day within the date range (e.g., Saturday and Sunday between 10:00 AM and 8:00 PM) during which the content item may be presented.

In some embodiments, the online system 140 may store 305 the content item (e.g., in the content store 210). The online system 140 may store 305 the content item in association with various types of information associated with the content item. For example, the online system 140 may store 305 the content item in the content store 210 in association with information identifying the content-providing user 302 from whom the content item was received 300. As an additional example, the online system 140 may store 305 the content item in association with information specified by a content-providing user 302 from whom the content item was received 300 that identifies one or more content publishers 130 to which the content item is to be provided and one or more revenue performance metrics to be tracked during a particular time period. In the above example, the online system 140 also may store 305 the content item in association with information specified by the content-providing user 302 that describes one or more time intervals during which the content item is to be presented to online system users or to other individuals 304.

In some embodiments, the online system 140 may generate 310 (e.g., using the tracking module 230) one or more tracking mechanisms (e.g., tracking pixels) used to track various performance metrics (e.g., impression performance metrics, revenue performance metrics, interaction performance metrics, etc.) for a content item. A tracking mechanism allows the online system 140 to track a performance metric for a content item by collecting various types of information describing the performance metric. For example, to track impression performance metrics and interaction performance metrics for a content item, a tracking mechanism may collect information describing each impression of the content item and information describing each click on the content item, respectively. As an additional example, to track revenue performance metrics for a content item, a tracking mechanism may collect information describing each purchase associated with the content item.

In some embodiments, a tracking mechanism generated 310 by the online system 140 is a tracking pixel. For example, the online system 140 may generate 310 code corresponding to a tracking pixel that is a transparent 1×1 pixel image (e.g., a GIF, a JPEG, or a PNG file). The code corresponding to a tracking pixel allows information describing a request to present a content item or a page associated with the content item to be communicated to the online system 140. For example, a tracking pixel embedded into a content item may track impression performance metrics for the content item by collecting information describing requests to present the content item to various individuals 304 at multiple content publishers 130. As an additional example, a tracking pixel embedded into a purchase confirmation page associated with a content item may track revenue performance metrics for the content item by collecting information describing purchases associated with the content item that were made by various individuals 304.

In some embodiments, the online system 140 may set 310 (e.g., using the tracking module 230) a tracking mechanism, such as a cookie, to track performance metrics for the content item. For example, tracking cookies may be used to track impression performance metrics for a content item by collecting information describing requests to present the content item to the same individual 304 at multiple content publishers 130. To track a performance metric for the content item using a cookie, the online system 140 may set 310 the cookie to store and to return information describing the performance metric to the online system 140. For example, upon receiving a request to present a content item at a content publisher 130, the online system 140 may set 310 a cookie by sending instructions to a browser on a client device 110 from which the request was received to store information describing the request in the cookie and to send the cookie back in conjunction with future requests communicated to a server (e.g., the web server 260) at the online system 140. In this example, upon receiving a request to present content on the same client device 110 at a different content publisher 130, the online system 140 also may receive the cookie from the browser.

In some embodiments, the online system 140 may embed 315 (e.g., using the tracking module 230) a tracking mechanism into the content item to track information describing various performance metrics for the content item. For example, to track impressions of a content item, the online system 140 may embed 315 code corresponding to a tracking pixel into the content item. In this example, when a server (e.g., the web server 260) at the online system 140 receives a request to present the content item at a content publisher 130, the server also may receive various types of information describing the request via the tracking pixel (e.g., a client device identifier, such as an IP address, associated with a client device 110 from which the request is being received, information identifying the content publisher 130 at which the content item is to be presented, a date/time of the request, etc.).

In various embodiments, the online system 140 also may embed 315 a tracking mechanism into a web page associated with the content item. For example, to track clicks on a content item, the online system 140 may embed 315 code corresponding to a tracking pixel into a landing page for a link included in the content item. In this example, when a server (e.g., the web server 260) at the online system 140 receives a request to present the landing page to an individual 304, the server also may receive an IP address associated with a client device 110 from which the request is being received, information describing the content publisher 130 at which the content item was presented, a date/time of the request, etc. As an additional example, to track conversions (e.g., website registrations, purchases, etc.) associated with a content item, the online system 140 may embed 315 code corresponding to a tracking mechanism into a web page associated with the content item (e.g., a registration confirmation page, a checkout confirmation page, etc.). In this example, when a server (e.g., the web server 260) at the online system 140 receives a request to present the web page to an individual 304, the server also may receive an IP address associated with a client device 110 from which the request is being received, information describing the goods purchased/services subscribed, a date/time of the request, etc.

In some embodiments, the online system 140 may store 317 (e.g., using the tracking module 230) one or more tracking mechanisms in a browser on one or more client devices 110. For example, when a server (e.g., the web server 260) at the online system 140 receives a request associated with a content item (e.g., a request to present the content item), the online system 140 may store 317 a cookie in a browser at a client device 110 from which the request was received. A cookie may record various types of information describing actions that may be performed by an individual 304 across multiple websites. For example, a cookie may store 317 information identifying a content publisher 130 at which a particular content item was presented, user identifying information associated with an individual 304 to whom the content item was presented (e.g., based on an IP address, on a user agent, or on other information that is unique to the individual 304), a date/time of the presentation, information describing a purchase of goods/services featured in the content item, a geographic location of the individual 304 to whom the content item was presented (e.g., based on GPS coordinates of the individual's client device 110), etc. As described above, once a cookie has been set 310 to store information describing the request and to be sent back to the online system 140 in conjunction with future requests communicated to a server (e.g., the web server 260) at the online system 140, upon receiving a request to present content on the same client device 110 at a different content publisher 130, the online system 140 may receive the cookie from the browser. As shown in FIG. 3A, in some embodiments, the online system 140 may store 317 a tracking mechanism in a browser on a client device 110 upon presentation of the content item to one or more individuals 304 by a content publisher 130.

Once the online system 140 has embedded 315 the tracking mechanism into the content item and/or into a page associated with the content item and/or stored 317 the tracking mechanism in one or more browsers, the online system 140 may provide 320 the content item to one or more content publishers 130 for presentation to various individuals 304. The content item may be provided 320 to a content publisher 130 in conjunction with various types of information. In some embodiments, the content item may be provided 320 to a content publisher 130 in conjunction with targeting criteria describing online system users or other individuals 304 eligible to be presented with the content item (e.g., geographic locations associated with the online system users/individuals 304). The content item also may be provided 320 to a content publisher 130 in conjunction with information describing one or more time intervals during which the content item is to be presented to online system users or to other individuals 304. For example, the content item may be provided 320 in conjunction with information describing a date range (e.g., the first three months of a particular year) and a time of day within the date range (e.g., Monday through Friday between 7:00 AM and 6:00 PM) during which the content item may be presented.

In some embodiments, the content item may be provided 320 to a content publisher 130 in conjunction with information maintained in the online system 140 describing attributes associated with online system users. In such embodiments, the online system 140 may obfuscate user identifying information associated with online system users prior to exporting the information to the content publisher 130. For example, the online system 140 may encrypt various types of user identifying information by using a cryptographic hash function to create hashes of users' login information and first and last names before providing the information to a content publisher 130.

Each content publisher 130 to which the content item was provided 320 may then present 325 the content item to various individuals 304. For example, if a content item is an advertisement, a content publisher 130 may present 325 the content item to an individual 304 in a banner on a web page. As an additional example, a content item may be included among additional content items presented 325 to an individual 304 via a scrollable feed. In some embodiments, a content publisher 130 may present 325 the content item to an individual 304 based on information provided 320 by the online system 140 (e.g., based on geographic locations associated with the individuals 304, based on information describing one or more time intervals during which the content item is to be presented, etc.). As described above, in some embodiments, the online system 140 may store 317 a tracking mechanism in a browser on one or more client devices 110 upon presentation of the content item to one or more individuals 304 by a content publisher 130 (e.g., when the web server 260 receives a request to present the content item).

For each content publisher 130 to which the content item was provided 320, the online system 140 may receive 330 (e.g., using the web server 260) information describing one or more performance metrics for the content item presented 325 by the content publisher 130. In some embodiments, the performance metric(s) may correspond to one or more revenue performance metrics. For example, information describing revenue performance metrics may describe a dollar amount of each purchase associated with a content item. In other embodiments, the performance metric(s) may correspond to one or more interaction performance metrics. For example, information describing interaction performance metrics may describe a number of clicks on a content item during a particular time period. In additional embodiments, the performance metric(s) may correspond to one or more impression performance metrics. For example, information describing impression performance metrics may describe a number of presentations of a content item during a particular time period.

The information describing one or more performance metrics received 330 by the online system 140 may be received 330 from a tracking mechanism. In some embodiments, the online system 140 receives 330 information describing a performance metric from a cookie. For example, the online system 140 may receive 330 information describing impression performance metrics for a content item from a cookie that describes when the content item was previously presented 325 to an individual 304, information identifying one or more content publishers 130 at which the content item was previously presented 325 to the individual 304, etc. In this example, information received 330 from the cookie also may describe interaction performance metrics for the content item, such as when the individual 304 clicked on the content item, information identifying a content publisher 130 that presented 325 the content item on which the individual 304 clicked, etc.

In some embodiments, the online system 140 receives 330 information describing a performance metric via a tracking pixel. For example, when the web server 260 receives a request to present a content item at a content publisher 130, the online system 140 also may receive 330 various types of information describing the request via a tracking pixel embedded 315 into the content item. In this example, the information received 330 may include an IP address associated with a client device 110 from which the request is being received, information identifying the content publisher 130 at which the content item is to be presented 325, a date/time of the request, etc.

For each content publisher 130 to which the content item was provided 320, the online system 140 may store 335 (e.g., in the content store 210) the information describing the performance metric(s) (e.g., revenue performance metrics, interaction performance metrics, impression performance metrics, etc.) for the content item presented 325 by the content publisher 130. The information describing the performance metric(s) for the content item may include information identifying the content publisher 130 that presented 325 the content item. For example, if a content item was presented 325 to various individuals 304 by multiple content publishers 130, information describing impression performance metrics for each content publisher 130 that presented 325 the content item may indicate an identity of the content publisher 130, such as a name of the content publisher 130, an identification number of the content publisher 130, or any other unique identifier that may be used to identify the content publisher 130. Information describing a performance metric may describe individuals 304 associated with the performance metric. In the above example, the impression performance metrics for each content publisher 130 also may indicate a client device identifier or other user identifying information associated with individuals 304 presented 325 with the content item. Furthermore, information describing a performance metric also may include dates or times associated with the performance metric. For example, impression performance metrics for a content item may indicate a date and time that the content item was presented 325 to an individual 304 by a content publisher 130. Information describing a performance metric also may describe any other suitable types of information associated with the performance metric. For example, information describing a revenue performance metric may indicate each good/service associated with a content item that was purchased, an amount of the purchase, a form of payment used, etc.

The online system 140 may store 335 information describing each performance metric for the content item in association with an object representing the content item. In some embodiments, the online system 140 may maintain a table or a log describing a performance metric for a content item, which is stored 335 in association with an object representing the content item. In such embodiments, each entry in the table or the log corresponds to information describing a presentation 325 of the content item by a content publisher 130 and/or the performance of an action in association with the presentation 325 of the content item by the content publisher 130. For example, the online system 140 may maintain a table describing impression performance metrics for a content item presented 325 by a content publisher 130, in which each entry in the table corresponds to information describing a presentation 325 of the content item to an individual 304 by the content publisher 130. In this example, the online system 140 may add a new entry to the table each time information describing an impression of the content item for an individual 304 at the content publisher 130 is received 330 (e.g., by the web server 260) at the online system 140. In this example, the table may be stored 335 (e.g., in the content store 210) in association with an object representing the content item.

For each content publisher 130 to which the content item was provided 320, the online system 140 may compare 340 (e.g., using the user identification module 235) user identifying information associated with each individual 304 presented 325 with the content item to user identifying information maintained in the online system 140. For example, the online system 140 accesses information previously received 330 using a tracking mechanism that describes the presentation 325 of a content item/the performance of actions in association with the presentation 325 of the content item (e.g., from the content store 210, from the action log 220 and/or from the edge store 225). In this example, the online system 140 then compares 340 an IP address associated with a client device 110 included in this information with an IP address stored in association with each user profile of various online system users (e.g., in the user profile store 205).

In embodiments in which a tracking mechanism is embedded 315 into a page associated with a content item to track performance metrics associated with actions performed by individuals 304 in association with being presented 325 with the content item by a content publisher 130 (e.g., interaction performance metrics or revenue performance metrics), the online system 140 may compare 340 user identifying information collected using multiple tracking mechanisms. For example, the online system 140 may compare 340 a client device identifier collected using a tracking pixel embedded 315 into a content item to a client device identifier collected using a different tracking pixel embedded 315 into a purchase confirmation page associated with the content item. In some embodiments, the online system 140 also may compare dates/times at which user identifying information collected using different tracking mechanisms was received 330 (e.g., if the content item was presented 325 to the same individual 304 by multiple content publishers 130), as further described below.

For each content publisher 130 to which the content item was provided 320, the online system 140 may identify 345 (e.g., using the user identification module 235) one or more users of the online system 140 included among the individuals 304 based on the comparison. For example, the online system 140 may identify 345 an individual 304 presented 325 with the content item as an online system user if a user profile of the online system user is associated with user identifying information (e.g., an IP address) that matches the user identifying information that was received 330 using the tracking mechanism. In some embodiments, the online system 140 also may identify 345 one or more online system users included among the individuals 304 who were presented 325 with a content item by a content publisher 130 and/or who performed an action in association with being presented 325 with the content item by the content publisher 130 based in part on a date/time of the presentation 325/the performance of the action. For example, the online system 140 may identify 345 a set of individuals 304 who were presented 325 with a content item by a content publisher 130 during a particular time range (e.g., within the last month). In this example, the online system 140 may then identify 345 one or more online system users included among this set of individuals 304.

In some embodiments, a content publisher 130 may identify 345 online system users included among the individuals 304 who were presented 325 with a content item by a content publisher 130 and/or who performed an action in association with being presented 325 with the content item by the content publisher 130. For example, if the online system 140 previously provided information maintained in the online system 140 describing attributes associated with online system users to a content publisher 130 (e.g., obfuscated user identifying information), the content publisher 130 may identify 345 online system users included among the individuals 304 using the information provided by the online system 140, as described above.

In embodiments in which the online system 140 embeds 315 a tracking pixel into a page associated with the content item to track actions performed by individuals 304 in association with being presented 325 with the content item by the content publisher 130, the online system 140 may first identify the individuals 304 based on comparisons of information collected using multiple tracking mechanisms. For example, the online system 140 may identify an individual 304 associated with a client device 110 as an individual 304 who made a purchase in association with being presented 325 with a content item by a content publisher 130 if a client device identifier received 330 using a tracking pixel embedded 315 into the content item matches a client device identifier received 330 using a different tracking pixel embedded 315 into a purchase confirmation page associated with the content item. The online system 140 also may identify such individuals 304 based on a comparison of dates/times at which information was received 330 using multiple tracking mechanisms. In the above example, the online system 140 also may identify the individual 304 as an individual 304 who made a purchase in association with being presented 325 with the content item by the content publisher 130 if a server (e.g., the web server 260) at the online system 140 received a request to present a purchase confirmation page to the individual 304 after and within a threshold amount of time at which the server received a request to present 325 the content item to the individual 304 at the content publisher 130.

In embodiments in which a content item was presented 325 to the same individual 304 by multiple content publishers 130, the online system 140 may identify the individual 304 as an individual 304 who performed an action in association with being presented 325 with the content item by a particular content publisher 130. In such embodiments, the online system 140 may identify the individual 304 based on a comparison of a date/time at which information was collected using a tracking pixel embedded 315 into the content item presented 325 by each content publisher 130 to a date/time at which information was collected using a tracking pixel embedded 315 into a page associated with the content item. For example, the online system 140 may identify an individual 304 as an individual 304 who made a purchase in association with being presented 325 with an advertisement by a particular content publisher 130 if a server (e.g., the web server 260) at the online system 140 received a request to present 325 the advertisement to the individual 304 at the content publisher 130 at a time that is prior to and closest to the time at which the server received a request to present the purchase confirmation page to the individual 304.

In some embodiments, the online system 140 may generate 350 (e.g., using the user interface generator 255) a request for information from online system users. The online system 140 may generate 350 a request for information from online system users included among the individuals 304 who were presented 325 with the content item by a content publisher 130 and/or who performed an action in association with being presented 325 with the content item by the content publisher 130. For example, the online system 140 may generate 350 a poll or a survey inquiring whether online system users recall being presented 325 with a content item and/or performing an action in association with being presented 325 with the content item.

In embodiments in which the online system 140 generates 350 a request for information from the online system users, the online system 140 may communicate 355 the request for information to the online system users. For example, the online system 140 may communicate 355 a poll, a questionnaire, or a survey to an online system user via email or instant message inquiring whether the user recalls being presented 325 with a content item or performing an action in association with being presented 325 with the content item.

In embodiments in which the online system 140 communicates 355 a request for information from online system users, the online system 140 may store 365 each response received 360 from an online system user. In some embodiments, the online system 140 stores 365 responses to requests for information from online system users as attributes for the corresponding users. For example, upon receiving 360 a response to the request for information, the online system 140 may store 365 information describing the user's response as an attribute associated with the user's profile in the user profile store 205.

For each content publisher 130 to which the content item was provided 320, the online system 140 retrieves 370 (e.g., using the attribute association module 240) a set of attributes associated with the online system users included among the individuals 304. Examples of attributes that may be associated with an online system user include demographic information (e.g., age, gender, income level, geographic location, etc. associated with the user), hobbies/interests of the user, actions performed by the user that are internal or external to the online system 140, connections established between the user and other users or objects maintained in the online system 140, or any other suitable information associated with an online system user that may be maintained in the online system 140. For example, the online system 140 may retrieve 370 an age, a gender, a household income, a highest educational level, and a geographic location stored in association with a user profile of an online system user from the user profile store 205. As an additional example, the online system 140 may retrieve 370 information stored in association with edges between a user of the online system 140 and an additional user of the online system 140 from the edge store 225. In this example, the information stored in association with the edges may describe a relationship between the users, communications sent between the users in the online system 140, etc. As yet another example, the online system 140 may retrieve 370 information describing actions performed by an online system user in the online system 140 (e.g., commenting on a content item, checking in to a physical location associated with a content item, etc.) from the action log 220.

For each content publisher 130 to which the content item was provided 320, the online system 140 determines 375 (e.g., using the attribute association module 240) a number of online system users included among the individuals 304 having each of the set of attributes. The online system 140 may make this determination based on information maintained in the online system 140 associated with each of the online system users (e.g., information stored in the user profile store 205, in the action log 220, and/or in the edge store 225). For example, after retrieving 370 various attributes associated with online system users included among individuals 304 who were presented 325 with a content item by a content publisher 130 and/or who performed an action in association with being presented 325 with the content item by the content publisher 130 (e.g., from the user profile store 205), the online system 140 may determine 375 a number of the users who have a particular attribute (e.g., who recalled being presented 325 with the content item three days after being presented 325 with the content item and who live in a particular geographic region). In some embodiments, the online system 140 may determine 375 a percentage or a proportion of online system users having a particular attribute. In the above example, the online system 140 may determine 375 a percentage or a ratio of the online system users included among the individuals 304 who were presented 325 with a content item by a content publisher 130 and/or who performed an action in association with being presented 325 with the content item by the content publisher 130 who have the particular attribute.

In embodiments in which a content publisher 130 identifies 345 online system users included among the individuals 304 who were presented 325 with a content item by the content publisher 130 and/or who performed an action in association with being presented 325 with the content item by the content publisher 130, the content publisher 130 may determine 375 a number of online system users included among the individuals 304 who have a particular attribute, as described above.

In response to determining 375 a number of online system users included among individuals 304 having each of the set of attributes, for each content publisher 130 to which the content item was provided 320, the online system 140 may extrapolate 380 (e.g., using the extrapolation module 245) a set of the individuals 304 who also have each of the set of attributes. The number of individuals 304 included in the set of individuals 304 extrapolated 380 by the online system 140 represents the number of individuals 304 who are likely to have an attribute based on a number or on a percentage of online system users included among the individuals 304 who have the attribute. For example, if a certain percentage of online system users included among individuals 304 who were presented 325 with a given content item by a given content publisher 130 have a particular attribute, the online system 140 may use this percentage to extrapolate 380 a number of the individuals 304 who were presented 325 with the same content item by the same content publisher 130 who are likely to have the attribute.

In some embodiments, the online system 140 may extrapolate 380 the set of the individuals 304 having each of the set of attributes based on a ratio or on a percentage of users of the online system 140 included among the individuals 304 having each of the set of attributes, such that the ratio or the percentage of individuals 304 included in the set is proportional to the ratio or the percentage of the online system users having the attribute. For example, if 23% of online system users who are presented 325 with a content item by a content publisher 130 and who make a purchase in association with being presented 325 with the content item are married, female, between the ages of 35 and 40, and have an income between $80,000 and $90,000, the online system 140 may extrapolate 380 that 23% of the individuals 304 who are presented 325 with the content item by the content publisher 130 and who make a purchase in association with being presented 325 with the content item also are married, female, between the ages of 35 and 40, and have an income between $80,000 and $90,000. As an additional example, the online system 140 may determine 375 that two out of 10 online system users who are presented 325 with a content item by a content publisher 130 and who subsequently visit a physical location associated with the content item (e.g., by checking-in to the physical location with a mobile device) are male, between the ages of 12 and 17, and live in an apartment, the online system 140 may extrapolate 380 that two out of 10 of the individuals 304 who are presented 325 with the content item by the content publisher 130 and who visit the physical location associated with the content item also are male, between the ages of 12 and 17, and live in an apartment.

In some embodiments, the online system 140 also may extrapolate 380 the set of individuals 304 having each of the set of attributes based at least in part on a sampling method. For example, the online system 140 may randomly sample online system users identified from individuals 304 presented 325 with a content item by a content publisher 130 and determine a ratio or a percentage of the randomly sampled users associated with each of various age ranges and occupations. In this example, the online system 140 may then extrapolate 380 a set of individuals 304 who belong to each of the age ranges and who have various occupations based on the ratio or on the percentage of the sampled users who belong to each of the age ranges and who have the occupations. The online system 140 may use various types of sampling methods to extrapolate 380 the set of individuals 304 having each of the set of attributes. Examples of such sampling methods include simple random sampling, stratified sampling, cluster sampling, etc.

In various embodiments, the online system 140 may select a sampling method that de-biases the online system users included among the individuals 304 used to extrapolate 380 the set of individuals 304 having each of the set of attributes (e.g., if there is a known difference between the online system users presented 325 with the content item by a content publisher 130 and the individuals 304 presented 325 with the content item by the content publisher 130). For example, suppose it is known that individuals 304 presented 325 with a content item by a content publisher 130 on a client device 110 running on the iOS 10 operating system failed to track about half of the impressions of the content item, but was successful at tracking all impressions of the content item achieved by online system users. In this example, the online system 140 may select a sampling method, such as a stratified sampling method or a cluster sampling method, to sample the online system users who were presented 325 with the content item by the content publisher 130, in which the online system users are divided into strata or clusters based on the operating system running on the client devices 110 they used when they were presented 325 with the content item. Continuing with this example, since the tracking mechanism failed to track about half of the impressions of the content item presented 325 to individuals 304 using client devices 110 running the iOS 10 operating system, the online system 140 may sample an equal number of online system users from each stratum or cluster, but double the number of users sampled from the stratum or cluster including users who used client devices 110 running this operating system when they were presented 325 with the content item. In this example the online system 140 may then extrapolate 380 the set of individuals 304 associated with each of one or more attributes based on attributes associated with the sampled users.

In embodiments in which a content publisher 130 determines 375 a number of online system users included among the individuals 304 who were presented 325 with a content item by the content publisher 130 and/or who performed an action in association with being presented 325 with the content item by the content publisher 130 having each of the set of attributes, the content publisher 130 may extrapolate 380 the set of the individuals 304 who also have each of the set of attributes, as described above.

For each content publisher 130 to which the content item was provided 320, the online system 140 generates 385 (e.g., using the analytics generator 250) a set of analytics describing the performance metric(s) for the content item. The analytics generated 385 by the online system 140 may include various performance metrics (e.g., revenue performance metrics, interaction performance metrics, impression performance metrics, etc.) describing the individuals 304 and/or online system users included among the individuals 304 who were presented 325 with the content item by the content publisher 130 and/or who performed an action in association with being presented 325 with the content item by the content publisher 130. For example, the online system 140 generates 385 various analytics that include impression performance metrics for individuals 304 presented 325 with a content item by each of multiple content publishers 130, in which the impression performance metrics for each content publisher 130 indicate the number of individuals 304 who were presented 325 with the content item by the content publisher 130. In this example, the analytics also may indicate the number or percentage of online system users included among the individuals 304. Furthermore, in this example, the analytics may break down the impression performance metrics by each attribute associated with the individuals 304 and the online system users (e.g., by gender, client device 110 used to access the content item, geographic location, recollection of being presented 325 with the content item, etc.). In some embodiments, the online system 140 may generate 385 the set of analytics based on information received from the content-providing user 302. For example, the set of analytics may describe one or more performance metrics specified by the content-providing user 302 at the time the online system 140 received 300 the content item.

As shown in the example of FIG. 4, in some embodiments, analytics generated 385 by the online system 140 describing performance metrics 410 for a content item may be formatted into a table 400. The table 400 may indicate each content publisher 130 to which the content item was provided, as well as the type of performance metric 410 being tracked using the tracking mechanism. For example, the tracking mechanism may be used to track impressions 410A and conversions 410B, as shown in the example table 400.

The table 400 also may indicate the total number of individuals 304 presented 325 with a content item, a percentage of online system users 420 identified 345 from the total number of individuals 304, and an extrapolated number of individuals 430 for each performance metric 410. For example, the table 400 indicates that 29,606 impressions 410A were achieved by individuals 304 and that of these individuals 304, 68.8% were identified 345 as online system users. The percentage of online system users 420 who were identified 345 from the individuals 304 is broken down by the attribute of household income, such that 3.5% of the individuals 304 who were identified 345 as online system users have a household income of less than $20,000, 5.6% of the individuals 304 who were identified 345 as online system users have a household income between $20,000 and $34,999, etc. Furthermore, the table 400 indicates that of the 29,606 impressions 410A achieved by individuals 304, 1,506 of the extrapolated individuals 430 have a household income of less than $20,000, 2,410 of the extrapolated individuals 430 have a household income between $20,000 and $34,999, etc.

As an additional example, the table 400 indicates that 875 conversions 410B were achieved by individuals 304 and that of these individuals 304, 71.3% were identified 345 as online system users. The percentage of online system users 420 who were identified 345 from the individuals 304 is similarly broken down by the attribute of household income, such that 2.5% of the individuals 304 who were identified 345 as online system users have a household income of less than $20,000, 1.6% of the individuals 304 who were identified 345 as online system users have a household income between $20,000 and $34,999, etc. Furthermore, the table 400 indicates that of the 29,606 conversions 410B achieved by individuals 304, 31 of the extrapolated individuals 430 have a household income of less than $20,000, 20 of the extrapolated individuals 430 have a household income between $20,000 and $34,999, etc.

In embodiments in which a content publisher 130 extrapolates 380 a set of the individuals 304 who are associated with a particular attribute, the content publisher 130 also may generate 385 the analytics describing the individuals 304 and/or online system users included among the individuals 304 who were presented 325 with a content item by one or more content publishers 130 and/or who performed an action in association with being presented 325 with a content item by the content publishers 130, as described above. In such embodiments, once the content publisher 130 has generated 385 the analytics, the content publisher 130 may communicate them to the online system 140 and/or to a user of the online system 140 associated with the content item (e.g., a content-providing user 302 of the online system 140).

Referring back to FIG. 3B, the online system 140 may generate 390 (e.g., using the user interface generator 255) a user interface including various analytics associated with the content item. In some embodiments, the user interface generated 390 by the online system 140 is a report that includes various analytics associated with a content item. For example, a report generated 390 by the online system 140 may include various charts, graphs, and insights based on analytics that are associated with a content item.

The online system 140 may communicate 395 the set of analytics describing the performance metric for the content item to the content-providing user 302 of the online system 140 and/or a user of the online system 140 associated with the content item. For example, if the content item is an advertisement, the online system 140 may communicate 395 the user interface including analytics associated with the advertisement to an advertiser who provided the advertisement. In embodiments in which the online system 140 generates 390 a report that includes the analytics associated with the content item, the online system 140 may communicate 395 the report to the content-providing user 302 of the online system 140.

The online system user to whom the analytics are communicated 395 may use the analytics to more closely tailor a content item to individuals 304 who may be presented 325 with the content item by each of the content publishers 130. For example, if the online system user is an advertiser for an appliance store who provided a content item to the online system 140, analytics provided by the online system 140 may indicate that a majority of individuals 304 presented 325 with the content item by a first content publisher 130 are homeowners while a majority of individuals 304 presented 325 with the content item by a second content publisher 130 are not homeowners, but are college students. In this example, after receiving the analytics associated with the advertisement, the advertiser may provide an advertisement to the first content publisher 130 that features appliances that homeowners are likely to purchase (e.g., ovens, washers, and dryers) while the advertiser may provide a different advertisement to the second content publisher 130 that features appliances that college students are likely to purchase (e.g., microwaves and mini refrigerators).

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, a content item from a content-providing user of the online system, the content item to be presented to individuals by one or more content publishers;
providing the content item to the one or more content publishers, the content item comprising a tracking mechanism for tracking a performance metric for the content item;
for each content publisher of the one or more content publishers:
receiving information describing the performance metric for the content item presented by the content publisher, the information comprising user identifying information associated with each of one or more individuals of a plurality of individuals to whom the content item was presented and information identifying the content publisher that presented the content item to each of the one or more individuals;
comparing the user identifying information associated with each of the one or more individuals to information maintained in the online system describing each of a plurality of users of the online system;
identifying one or more users of the online system from the plurality of individuals based at least in part on the comparing, the one or more users of the online system associated with information maintained in the online system matching the user identifying information associated with the one or more individuals;
retrieving a set of attributes for the one or more users of the online system;
determining a number of the one or more users of the online system having each of the set of attributes;
extrapolating a set of individuals from the plurality of individuals having each of the set of attributes in response to determining the number of the one or more users of the online system having each of the set of attributes;
generating a set of analytics describing the performance metric for the content item for the plurality of individuals presented with the content item by the content publisher, the set of analytics comprising information describing the set of individuals extrapolated from the plurality of individuals having each of the set of attributes; and
communicating the set of analytics describing the performance metric for the content item for the plurality of individuals presented with the content item by each of the one or more content publishers to the content-providing user of the online system.

2. The method of claim 1, wherein identifying one or more users of the online system from the plurality of individuals is further based at least in part on a sampling method.

3. The method of claim 2, further comprising:
selecting the sampling method based at least in part on a bias associated with the one or more users of the online system identified from the plurality of individuals.

4. The method of claim 1, wherein the set of analytics further comprises information describing the set of attributes for the one or more users of the online system.

5. The method of claim 1, wherein extrapolating the set of individuals from the plurality of individuals having each of the set of attributes comprises:
computing a percentage of the one or more users of the online system having each of the set of attributes; and
determining the set of individuals having each of the set of attributes, the set of individuals proportional to the percentage of the one or more users of the online system having each of the set of attributes.

6. The method of claim 1, wherein the tracking mechanism comprises a tracking pixel.

7. The method of claim 1, further comprising:
embedding the tracking mechanism into the content item.

8. The method of claim 1, wherein the tracking mechanism comprises a cookie.

9. The method of claim 1, wherein the user identifying information comprises a client device identifier.

10. The method of claim 1, wherein the performance metric for the content item describes a number of impressions achieved by the content item, a number of conversions achieved by the content item, or a number of clicks on the content item.

11. The method of claim 1, wherein the set of attributes comprises one or more selected from a group consisting of: demographic information, an interest, an action performed, and any combination thereof.

12. A computer program product comprising a computer readable storage medium having instructions encoded thereon that, when executed by a processor, cause the processor to:
receive, at an online system, a content item from a content-providing user of the online system, the content item to be presented to individuals by one or more content publishers;
provide the content item to the one or more content publishers, the content item comprising a tracking mechanism for tracking a performance metric for the content item;
for each content publisher of the one or more content publishers:
receive information describing the performance metric for the content item presented by the content publisher, the information comprising user identifying information associated with each of one or more individuals of a plurality of individuals to whom the content item was presented and information identifying the content publisher that presented the content item to each of the one or more individuals;
compare the user identifying information associated with each of the one or more individuals to information maintained in the online system describing each of a plurality of users of the online system;
identify one or more users of the online system from the plurality of individuals based at least in part on the compare, the one or more users of the online system associated with information maintained in the online system matching the user identifying information associated with the one or more individuals;
retrieve a set of attributes for the one or more users of the online system;
determine a number of the one or more users of the online system having each of the set of attributes;
extrapolate a set of individuals from the plurality of individuals having each of the set of attributes in response to determine the number of the one or more users of the online system having each of the set of attributes;
generate a set of analytics describing the performance metric for the content item for the plurality of individuals presented with the content item by the content publisher, the set of analytics comprising information describing the set of individuals extrapolated from the plurality of individuals having each of the set of attributes; and
communicate the set of analytics describing the performance metric for the content item for the plurality of individuals presented with the content item by each of the one or more content publishers to the content-providing user of the online system.

13. The computer program product of claim 12, wherein identify one or more users of the online system from the plurality of individuals is further based at least in part on a sampling method.

14. The computer program product of claim 13, wherein the computer readable storage medium further has instructions encoded thereon that, when executed by the processor, cause the processor to:
select the sampling method based at least in part on a bias associated with the one or more users of the online system identified from the plurality of individuals.

15. The computer program product of claim 12, wherein the set of analytics further comprises information describing the set of attributes for the one or more users of the online system.

16. The computer program product of claim 12, wherein extrapolate the set of individuals from the plurality of individuals having each of the set of attributes comprises:
compute a percentage of the one or more users of the online system having each of the set of attributes; and
determine the set of individuals having each of the set of attributes, the set of individuals proportional to the percentage of the one or more users of the online system having each of the set of attributes.

17. The computer program product of claim 12, wherein the tracking mechanism comprises a tracking pixel.

18. The computer program product of claim 12, wherein the computer readable storage medium further has instructions encoded thereon that, when executed by the processor, cause the processor to:
embed the tracking mechanism into the content item.

19. The computer program product of claim 12, wherein the tracking mechanism comprises a cookie.

20. The computer program product of claim 12, wherein the user identifying information comprises a client device identifier.

21. The computer program product of claim 12, wherein the performance metric for the content item describes a number of impressions achieved by the content item, a number of conversions achieved by the content item, or a number of clicks on the content item.

22. The computer program product of claim 12, wherein the set of attributes comprises one or more selected from a group consisting of: demographic information, an interest, an action performed, and any combination thereof.

23. A method comprising:
receiving, at an online system, a content item from a content-providing user of the online system, the content item to be presented to a plurality of individuals by a content publisher;
providing the content item to the content publisher, the content item associated with a tracking mechanism for tracking a performance metric for the content item;
receiving information describing the performance metric for the content item presented by the content publisher, the information comprising user identifying information associated with each of one or more individuals of the plurality of individuals to whom the content item was presented;
comparing the user identifying information associated with each of the one or more individuals to information maintained in the online system describing each of a plurality of users of the online system;
identifying one or more users of the online system from the plurality of individuals, the one or more users of the online system associated with information maintained in the online system matching the user identifying information associated with the one or more individuals;
retrieving a set of attributes for the one or more users of the online system;
determining a number of the one or more users of the online system having each of the set of attributes;
extrapolating a set of individuals from the plurality of individuals having each of the set of attributes in response to determining the number of the one or more users of the online system having each of the set of attributes;
and
generating a report comprising a set of analytics describing the performance metric for the content item for the plurality of individuals presented with the content item by the content publisher, the set of analytics comprising information describing the set of individuals extrapolated from the plurality of individuals having each of the set of attributes.

24. The method of claim 23, further comprising:
communicating the report to the content-providing user of the online system.

25. The method of claim 24, wherein the tracking mechanism for tracking the performance metric for the content item is embedded into one or more of the content item and a web page associated with the content item.
